(19) United States
(12) Patent Application Publication
(10) Pub. No.: US 2019/0179605 A1
(43) Pub. Date: Jun. 13, 2019

(54) AUDIO DEVICE AND A SYSTEM OF AUDIO DEVICES

(71) Applicant: Zound Industries International AB, Stockholm (SE)

(72) Inventors: Wessels Stefan, Stockholm (SE); Bergström Konrad, Stockholm (SE)

(21) Appl. No.: 16/325,627

(22) PCT Filed: Aug. 29, 2017
(86) PCT No.: PCT/EP2017/071604

§ 371 Date: Feb. 14, 2019

Related U.S. Application Data
(60) Provisional application No. 62/380,826, filed on Aug. 29, 2016.

(51) Int. Cl. G06F 3/16; G06F 3/01; H04R 1/10; H04R 27/00

(52) U.S. Cl. CPC G06F 3/165; G06F 3/017; G06F 3/167; H04R 1/1041; H04R 2499/11; H04R 2227/003; H04R 2227/005; H04R 2420/07; H04R 2460/07; H04R 27/00

(57) ABSTRACT

An audio device (2) configured to output audio content, comprising; —a controller (30) and; —at least a first sensor (40) configured to detect at least one usage parameter, wherein the controller is (30) is configured to receive sensor information from the sensor (40) indicative of the at least one usage parameter and; —based on the sensor information control the settings of the audio device (2).

### TECHNICAL FIELD

In general the present disclosure relates to an audio device. The present disclosure also relates to a system of audio devices.

### BACKGROUND ART

Nowadays portable electronic devices, such as mobile telephones (sometimes referred to as smart phones) or tablet computers, are a central item for users not only for wireless or wired communication but also for internet browsing and for listening to audio, such as music, pod cast or talk radio. For example, users may listen to audio in headphones or loudspeakers that are connected to a smart phone (or tablet computer) which contains music files or is connected to a streaming service for music or data. This setup may require that the user, who wants to listen to audio, need to have constant access to the smart phone which may be cumbersome in certain situations.

### SUMMARY OF THE TECHNOLOGY

In view of the above background, there is a demand for a more flexible system for listening to audio content. In order to meet this demand an audio device is provided which is configured to output audio content and comprises a controller and at least a first sensor configured to detect at least one usage parameter, wherein the controller is configured to receive sensor information from the sensor indicative of said at least one usage parameter and based on the sensor information control the settings of the audio device.

The usage parameter is a parameter relating to an action or a state of a human user in the surroundings of the audio device. Such a parameter may be exemplified by, but not limited to, an action of the user, such as a gesture or voice command, or change of position of the user relative the audio device, or physical activity. Another example of a usage parameter is the psychological state of the user, for example the mood of the user, i.e. happy, sad, angry or indifferent. Another example is the physical state of the user, such as alert, tired, asleep or awake. Another example of a usage parameter is an identification parameter of user for example the voice or the digital imprints of the finger of a user. Another example of a usage parameter, is the position of a first audio device relative a second audio device or the geographical location of the user or the audio device.

The sensor may for example be position sensor, that detects the position of the human user relative the audio device. The position sensor may for example detect the distance and/or the angle between the user and the audio device. The sensor may be a sound sensor in the form of microphones that detect changes in user voice or predetermined voice commands from the user and/or predetermined gestures (by detection of ultrasonic sound). The sensor may also be a motion sensor that detects physical motion of the user. Other type of sensors for detecting user behavioral parameters include, but are not limited to temperature sensors, digital imprint sensors, proximity sensors, and touch sensors. The sensor may also be a presence sensor, that is configured to detect the mutual presence of a first and a second audio devices.

The controller may compare sensor information indicative of a current usage parameter/s with pre-stored predetermined values for the usage parameter/s. When the controller recognizes that sensor information is equal to, or approximate, pre-stored predetermined values, the controller controls the settings of the audio device to a predetermined settings. That is, the controller changes the current settings of the audio device to a predetermined settings of the audio device.

A main advantage of the audio device according to the present disclosure is that the audio device may form part of an audio system that adapts with a high degree of independence to actions or a present state of a user. This will further explained by the following example:

A user wakes in the morning. A microphone in an audio device according to the present disclosure, e.g. a loudspeaker system in the bedroom detects that the user is awake and starts morning playlist of music at low volume on loudspeakers nearest to user. The loudspeaker system communicates with lights that are compatible with loudspeaker to increase light levels in bedroom in sync with volume level of the music. As user leaves bedroom and moves into another room, devices use optical and audio sensors to determine location of user in house. As user enters the kitchen lights and music sync to users preferred morning setup for the kitchen. Based on normal times user takes to finish breakfast, loudspeakers can send a reminder if user is more than 5 minutes behind schedule. As user leaves house, the audio devices are aware and shuts down all loudspeakers in the home and transfers media playback to audio devices in form of headphones that user wears when commuting. Based on pre-stored previous requests from user the audio device will make best estimation of content to play to user. As user comes into work area, settings on headphones change noise cancellation properties to allow the user to hear conversations while listening to music. Personal notifications may be muted until lunch & after-work. As user leaves work headphones set noise cancellation mode and checks local audio content for any relevant or important updates. As user comes home and puts down headphones, music automatically moves to closest large speaker and sets lights based on genre of music. Two hours later the main speaker notifies the user that the headphones need to be recharged for the commute the next day. As the user sits on the couch and softly start to snore the microphone recognizes this and softly fades out music and lights or remind the user to get up and go to bed.

In detail, the sensor for detecting at least one usage parameter may be, or comprise, a position sensor that is configured to detect the position of a human user relative the first audio device. The sensor may thereby output sensor information to the controller indicative of the position of relative the first audio device. The controller may thereby be configured to recognize positions of a human user relative the first audio device and in response thereto control the settings of the audio device to a predetermined setting. Additionally or alternatively, the audio device may comprise a at least one loudspeaker that is configured to generate ultrasonic audio signals for gesture control. Accordingly, the sensor is, or comprises, a microphone configured to detect ultrasonic audio signals resulting from movement of at least a body part of a user and to output sensor information to the controller indicative of the movement of at least a body part of a user. Preferably, the controller is thereby configured for gesture control. The controller may thereby be configured to recognize sensor information indicative of a predetermined movement of at least a body part of a user and in response thereto control the settings of the audio device a predetermined setting of the audio device. Additionally or alternatively the sensor is, or comprises, a microphone configured to detect sound signals emanated from a human user and to output sensor information to the controller indicative of emanated sound signals from a user. The controller may thereby be configured for voice control. The controller may thereby be configured to recognize sensor information indicative of a predetermined sound signal emanated from a user and in response thereto control the settings of the audio device to a predetermined setting. For example, the controller may be configured to estimate the mood of a user based on sensor information indicative of predetermined movement of at least a body part of the user and/or predetermined sound signals emanated from a user. The controller may thereby be configured recognize sensor information indicative of a predetermined mood of the human user and in response thereto to control the settings of the audio device to a predetermined setting based on the estimated mood of the user. Additionally or alternatively, the sensor is, or comprises a motion detection sensor that is configured to determine physical movement of the user and to output sensor information to the controller indicative of body movement or body position of the user. The controller may thereby be configured to recognize sensor information indicative of predetermined body movement of the user and in response thereto control the settings of the audio device to a predetermined setting.

The audio device may further comprise a communication module configured for wireless communication. Preferably, the communication module is configured for wireless communication. For example, the communication module may be configured for wireless communication with another, i.e. different, audio device for example via a telecommunication network or the Internet. Preferably, the wireless communication is two-way wireless communication. The communication module may thereby comprise a mobile multi-band module configured for connection to a telecommunication network and/or a Bluetooth multi-band module configured for communication with another audio device and/or a Wi-Fi-multi-band module.

Additionally or alternative, the sensor for detecting a usage parameter outputs sensor information to the controller indicative of the position of a user relative the audio device, being a first audio device. The controller may thereby be configured to recognize predetermined sensor information indicative of the position of a user relative the audio device and in response thereto switch output of audio content from the first audio device to a second audio. Additionally or alternatively the sensor may output sensor information to the controller indicative of the mutual positions of a first audio device and a second audio device. The controller may thereby be configured to recognize sensor information indicative the mutual positions of a first audio device and second audio device and, in response thereto, switch output of audio content from one of the first and the second audio device to the other of the first and the second audio device.

Additionally or alternatively, the controller may be configured to recognize predetermined sensor information indicative of a usage parameter, and in response thereto, control a settings of a secondary device to a predetermined settings. The at least first secondary device may be a lighting device. The controller may thereby be configured to the control settings of emanated light from the least first secondary device based on sensor information.

According to alternatives, the predetermined settings of the at least first audio device may include one or more of: outputted audio content, power mode of the at least first audio device, sound settings of outputted audio content, interaction of the at least first audio device with additional audio devices or secondary devices, updating and/or synchronization of local settings on the device with remote settings. The predetermined settings of the audio device may be stored in a local memory device of said audio device. Additionally or alternatively, the predetermined settings of the audio device may be stored on a remote memory device that may be accessed by wireless communication.

According to a further aspect, the present disclosure relates to an audio system comprising at least a first and a second audio device, as disclosed above, wherein the first and the second audio device are configured for wireless operative communication with each other.

### BRIEF DESCRIPTION OF THE DRAWINGS

FIG. 1: A schematic drawing of an audio system according to an exemplary embodiment of the present disclosure.

FIG. 2: A schematic drawing of an audio device according to an exemplary embodiment of the present disclosure.

### DETAILED DESCRIPTION OF EMBODIMENTS

The audio device and the system of audio devices according to the present disclosure will now be described more fully hereinafter. The audio device and the system of audio devices according to the present disclosure may however be embodied in many different forms and should not be construed as limited to the embodiments set forth herein. Rather, these embodiments are provided by way of example so that this disclosure will be thorough and complete, and will fully convey the scope of the present disclosure to those persons skilled in the art. Same reference numbers refer to same elements throughout the description.

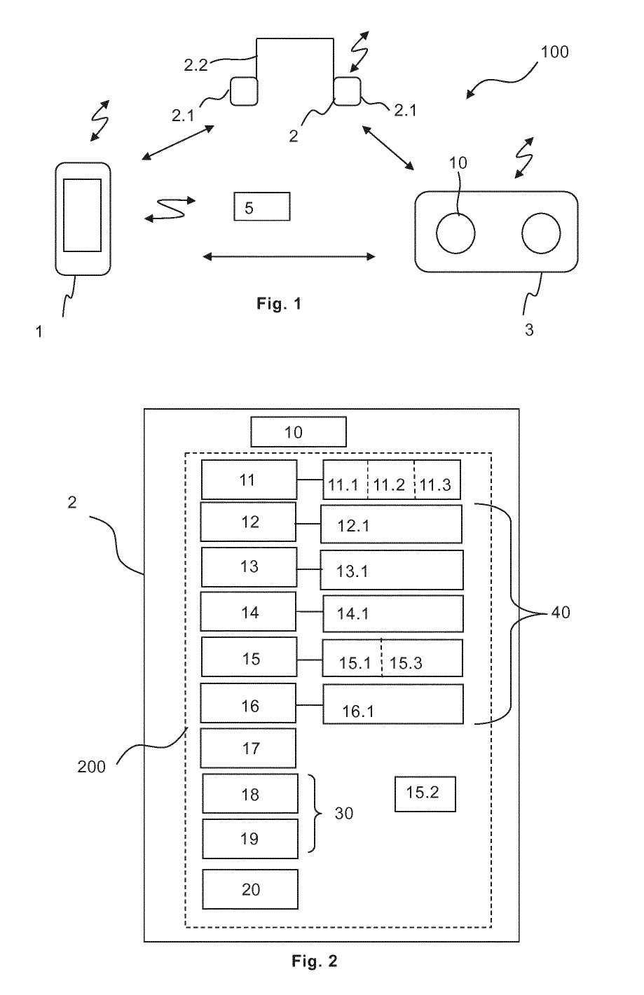

FIG. 1 shows an audio system 100 comprising a first audio device 1 in the form of a mobile telephone such as a smart phone, a second audio device 2 in the form of a pair of headphones (sometimes referred to as a headphone only) and a third audio device 3 in the form of a loudspeaker, or loudspeaker system. However, the audio system 100 may comprise more than three audio devices or only two audio devices. It is possible that the two or more or all audio devices are of the same type. For example, the audio system may comprise only audio devices in the form of headphones and loudspeaker systems.

The audio device may also be denominated audio listening device. The smart phone may for example be based in part on a Marshall smart phone, such as a London smart phone, which is commercially available from the company Zound Industries Smartphones AB. The headphone may for example be based in part on a Marshall headphone, such as a Marshall Monitor headphone, which is commercially available from the company Zound Industries International AB. The loudspeaker system may be based in part on a Marshall loudspeaker system, such as a Stockwell loudspeaker system, which is commercially available from the company Zound Industries International AB. FIG. 1 further shows a secondary device 5, which may be in wireless communication with the audio devices 1, 2, 3. The secondary device 5 may for example be a lightening device, i.e. an electric light source. The audio device 2 may also be denominated “audio listening device 2”.

The audio devices 1, 2, 3 are configured to output audio content, that is music, talk or any other sound that is perceivable by a human user (not shown). The audio devices may thereby comprise at least one loudspeaker 10. It is appreciated that the loudspeaker may be physically arranged in the audio device or remote from the audio device. That is, the loudspeaker may be connected by wire or wireless to the audio device. This setup may for example be used in a smart phone that may have a built-in loudspeaker or that is connected to a remote loudspeaker by an electric cord of by wireless connection.

The audio devices 1, 2, 3 are configured for wireless communication with each other and with networks such as mobile networks or Wi-Fi networks or Bluetooth or the Internet.

FIG. 2 shows schematically an audio device 2 according to an exemplary embodiment of the present disclosure. The audio device 2 comprises at least one loudspeaker 10 which is configured to output sound intended to be perceived by a human listener or other authenticated voice services. In the described exemplary embodiment, the audio device 2 is a headphone which may comprise two ear-cups 2.1 joined together by a headband 2.2 (see FIG. 1). A loudspeaker 10 (not shown) is arranged in each earcup 2.1.

While the audio device in the following is described with reference to a headphone it is appreciated that the following description is equivalently valid for an audio device in the form of a loudspeaker system or a smart phone. Moreover, in the following specific features are mainly described with reference to a first audio device. However, it is appreciated that in an audio system of more than a first audio device also further audio devices may comprises all or some of the features of the first audio device.

The audio device 2 may comprise a communication module 11 which is configured for wireless communication, preferably two-way wireless communication, to a mobile network, the Internet or to other devices. These devices may be other audio devices according to the present disclosure or other type of devices. For example one or more secondary devices, such as lighting devices. The communication module 11 may thereby comprise a mobile multi-band module 11.1 which is configured for wireless connection to mobile networks such as 3G, 4G or 5G. Additionally or alternatively, the communication module 11 may comprise a Bluetooth multi-band module 11.2 which is configured for Bluetooth communication. That is, configured to simultaneous sending and receiving Bluetooth data to and from one or more paired devices. Additionally or alternatively, the communication module may comprise a Wi-Fi multi-band module 11.3 which is configured for s. c. Wi-Fi communication. That is configured to join or create e.g. 2.4 or 5 GHz networks.

A main advantage with the communication module 11 is that the audio device, in form of e.g. a headphone or a loudspeaker system may operate independently of a smart phone. That is, the audio device, in form of e.g. a headphone or a loudspeaker system may independently connect to wireless networks and for example communicate to a provider of streamed music or streamed audio or mobile network voice & messaging services.

The audio device 2 further comprises a controller 30 for controlling the audio device. The controller comprises a memory 18 and a processor 19. The memory 18 may be configured to carry instructions that when loaded into the processor 19 of the electronic audio device 2 executes a method or procedure according to the exemplary embodiments disclosed in this disclosure. Loading of the instructions from the memory 18 into the processor may be performed by a computer data reading device (not shown). It should be noted that the memory 18 is a computer-readable medium such as a flash memory. However, also other memory technologies may be used such as ROM, RAM, SRAM, DRAM, DDR or SDRAM. The processor 19 may be any suitable, publically available processor or Programmable Logic Circuit (PLC). The instructions may alternatively be transmitted via a wireless interface (for example via the Internet) and the communication module 11 to the computer data reading device for loading the instructions into the processor 19 of the electronic audio device 2.

The controller 30 is configured to recognize predetermined sensor information indicative of a usage parameter and in response thereto control the settings of the audio device 2. Typically, the controller 30 therefore comprises pre-stored sensor information for at least one usage parameter and various configuration for determining when a predetermined sensor value is recognized. Such configuration may include various rules, instructions or threshold values. For example the controller may be configured to control the settings of the audio device to a predetermined settings based on: change of a usage parameter, duration of the change of the usage parameter, max and min values of the usage parameter, rate of change of the usage parameter or specific values of the usage parameter that has been previously reached.

The controller 30 further comprises pre-determined settings of the audio device 2. Such settings include, but are not limited to outputted audio content, power mode of at least a first audio device, sound settings of outputted audio content, interaction of the at least first audio device with additional audio devices or secondary devices, updating and/or synchronization of local settings on the device with remote settings. The predetermined settings of the audio device 2 may be stored in the memory 18 of the audio device.

However, it is also possible that the predetermined settings of the audio device 2 are stored on a remote memory device, for example a memory device on a remote server (not shown) that may be accessed by controller 30. For example by wireless communication.

According to the present disclosure, the audio device 2 comprises at least one sensor 40 for detecting at least one usage parameter. The sensor 40 may be arranged in the audio device or arranged remotely of the audio device and in wireless communication with the audio device. It is appreciated that the sensor 40 could be one single sensor that is configured to measure several different usage parameters. Analogous, the audio device 2 may comprise two or more individual sensors which respectively are configured to detect one or more usage parameters. The sensor 40 is connected to the controller 30 such that the controller 30 may receive sensor information indicative of a detected usage parameter.

The audio device 2 may therefore comprise a position sensor 12.1 which is configured to detect the position of the user relative the audio device 2. By “position” is meant the physical position of the user relative the audio device and includes both distance and angular position. The position sensor 12.1 may for example be a laser distance sensor alternatively the position sensor is a capacitive sensor. The position sensor 12.1 may further be configured to determine the mutual position of two or more audio devices.

The audio device 2 may further comprise a geographic location sensor 13.1 such as GPS multi band location module which allows for the use of GPS/GLONASS/Beidou satellite systems for determining geographical location when outdoors. Alternatively, the geographical position of the audio device may be determined by a mobile network, such as GSM or by Wi-Fi. The audio device 2 may thereby be configured to output audio content on basis of the geographical location of the audio device or the user. The location sensor 13.1 may also be useful in finding a lost audio device. The controller 30 may thereby be configured to repeatedly record the last known location of the audio device. The user may thereby retrieve the geographical location of the lost device by accessing it wireless by another device. This further makes possible for the user to wipe or reset the audio device remotely.

The controller 30 may be configured to control functions of the audio device in dependency of instructions, i.e. commands of the user of the audio device. According to one alternative, the controller 30 is configured for voice control. That is, the user may control the audio device by speaking out predetermined instructions. To enable voice control, (and other functionality) the audio device 2 may comprise a sound sensor in the form of at least one microphone 15.1 which is configured to detect a usage parameter in the form of audio signals emanated by the user. For example, the voice to the user. To increase audio pick up, the audio device 2 may comprise an array of several microphones arranged on the audio device. The microphone/s 15.1 may be a so called far field- or far reach microphone which is optimized for recording of audio at a distance of more than 1 meter from the audio device. This enables the user to speak voice commands without being concerned about which physical audio device will pick up his voice. This is favorable since the user should have to train or adjust as little as possible to the audio device. The microphone/s 15.1 may be a so called near reach microphone which is optimized for recording of audio within a distance of 1 meter from the audio device. Obviously, the provision of microphone/s 15.1 also enables use of the audio device for voice communication with other persons. Alternatively or additionally, the controller 30 may be configured for gesture control. That is, the user may control the audio device 2 by making predetermined gestures or movements with his body parts, e.g. the hands or arms. To enable gesture control, the audio device 2 may be provided with a micro loudspeaker 15.2 which is configured to generate and output ultrasonic tones for gesture control. The audio device 2 may further comprise a sound sensor in the form of a microphone 15.3 that is configured to record the ultrasonic signals. Alternatively, a further, separate and appropriately configured microphone (not shown) may be provided. Preferably, the user may use the same set of predetermined gestures or voice commands on all audio devices in an audio system. The micro loudspeaker may also be configured to output notifications to the user of the audio device, for instance.

The controller 30 may be configured to associate specific user moods with predetermined emotional markers in the recorded voice or gestures of the user. The controller 30 may further be configured to adjust the settings of the audio output with specific moods of the user. The audio device 2 may also comprise an Audio Codect containing DSP, input/output, lower power/high efficiency voice detection.

The audio device 2 may further comprise a motion detection sensor 14.1 such as an accelerometer, a gyroscope or a magnetometer. The motion detection sensor 14.1 is configured to detect and monitor physical movement or the physical position of the user of the audio device. The motion detection sensor 14.1 enables the controller 30 to control the settings of the audio device 2 by for example to adjust the audio content in dependency of the physical active of the user, such as fitness. The controller 30 may be configured to adjust the audio output in dependency of detected position of the user, in order to provide an optimal audio experience to the user. The controller 30 may also be configured to switch the audio device between On/Off based on the position, or the motion or the lack of motion of the user.

The controller 30 may further be configured to identify the user of the audio device. Preferably, the controller 30 is configured to identify the user prior to activating the audio device. The controller 30 may also be configured such that the user of the audio device is required to identify himself prior to performing certain actions or using certain functions of the audio device 2. The controller 30 may thereby be configured such that certain users have specific rights to use functions of the audio device. In addition, the audio device may be configured such that preferred settings, for example playlists, are coordinated with specific users that are identified by the controller 30. Typically, the controller 30 is configured to identify users of the audio device on basis of biometric data. According to one alternative the controller 30 is thereby configured to identify users of the audio device on basis of voice recognition based on sound signals detected by the microphone 15.1. Additionally or alternatively, the controller 30 may be configured to identify users of the audio device on basis of fingerprint patterns. The audio device may thereby comprise a fingerprint sensor 16.1.

The audio device may further comprise a vibration module 17 which is configured to notify the user, by vibrations, of preselected events. For example, the vibration module is a multi-voltage vibrator.

The controller 30 may be configured for handover, that is configured to switch the output of audio content from one audio device 2 according to the present disclosure to another audio device 2 according to the present disclosure, and/or vice versa. Typically, the controller 30 is configured to initiate the switch of audio output without manual intervention of the user, but based on a predetermined usage parameter. For example, the position sensor 12.1 may detect a user coming home and placing the smart phone or headphone close to loudspeaker system. The controller 30 may then automatically switch the audio output to the loudspeaker system. The motion sensor 13.1 may detect a user picking up the headphone in the morning when music is playing on the loudspeaker system. The controller 30 may then switch audio output to the headphone once it is picked up. The handover function may also be triggered by a handover signal transmitted between the audio devices in questions.

The audio device 2 may further be configured for synchronized playback. This is advantageous in an audio system 100 comprising several audio devices 2 connected to each other in a network. The user may thereby play the same audio stream on the multiple audio devices of the network. A whole group of users may thereby be ‘tuned’ to the same channel using different devices and an individual user has the ability to switch between devices without silencing others of the group.

The audio device may further comprise additional features such as: Multicolour LED notification light/s; 3.5 mm 4-pole jacks for input, output and daisy-chaining of stereo analog audio information; An M-button/Custom button for accessing brand or music specific features configured by manufacturer or user; Rotary/rocking controls for scrolling/rocking volume controls, rotary knobs and five way rocker switches in various coatings additionally provided with synched vibrational feedback from vibration unit; Push buttons for actions such as pairing or selecting functions; Built-in battery; External Memory Card Slot; Wireless Charging Module; NFC Module; Hall sensor, which may act a magnetic switch to power on/off headphone when unfolded, or flip cover over speaker or phone detection; USB connector.

An audio device in the form of a smart phone typically comprises a display and an audio device in the form of a loudspeaker system typically comprises at least one loudspeaker and at least one amplifier.

Preferably, the audio device 2 comprises a common module 200 which may comprise one or more of the functionality disclosed above. Preferably, the common module 200 is a separate physical unit. This provides the advantage of easy integration of the function modules described above in audio devices.

Preferably, specific functionality, disclosed above may be comprised in the common module 200 in the form of one or more functionality modules. A functionality module may comprise one or more sensors for detecting a usage parameter. The functionality module may further comprise configuration of the controller for recognizing predetermined sensor information indicative of said usage parameter and the control the settings of the audio device based on sensor information.

Thus, the common module 200 may comprise:

A communication module 11;

A position module 12, that may comprise a position sensor 12.1, and configuration of the controller 30 to recognize predetermined sensor information indicative of the position of user relative audio device 2 and, in response thereto, control the settings of the audio device to predetermined settings of the audio device 2;

A location module 13 that may comprise a location sensor 13.1 and configuration of the controller 30 to recognize predetermined sensor information indicative of the geographical position of user relative audio device 2 and, in response thereto, control the settings of the audio device to predetermined settings of the audio device 2;

A motion traction module 14 that may comprise a motion detection sensor 14.1 and configuration of the controller 30 to recognize sensor information indicative of a predetermined motion or position of the body of a user and, in response thereto control the settings of the audio device 2 to a predetermined settings of the audio device 2:

A user input module 15 that may comprise a is a microphone 15.3 configured to detect ultrasonic audio signals resulting from movement of at least a body part of a user and configuration of the controller 30 to recognize predetermined sensor information indicative of a movement of at least a body part of a user, and in response thereto control the settings of the audio device 2 to a predetermined setting of the audio device 2. The user input module 15 may also comprise a loudspeaker configured to output ultrasonic sound.

A user input module 15 that may comprise a microphone 15.1 configured to detect sound signals emanated from a user and configuration of the controller 30 to recognize predetermined sensor information indicative of a sound signal emanated from a user and, in response thereto control the settings of the audio device 2 to a predetermined settings of the audio device 2.

A user identification module 16 that may comprise a user identification sensor 15.1, 16.1 configured to detect a user identification parameter and configuration of the controller 30 to recognize predetermined sensor information indicative of user identification and in response thereto control the settings of the audio device 2 to a predetermined setting of the audio device 2.

A vibration module 17;

A handover module 20 that may comprise a position sensor 12.1 or a motion sensor 13.1 and configuration of the controller to recognize predetermined sensor information indicative of change of a usage parameter, switch output of audio content from a first audio device to a second audio device;

A controller 30 comprising a memory 18 and a processor 19.

The common module 200 may also comprise a built in memory for storage of audio applications, settings and cached data and a SIM-slot.

Although a particular embodiment has been disclosed in detail this has been done for purpose of illustration only, and is not intended to be limiting.

Moreover, although specific terms may be employed herein, they are used in a generic and descriptive sense only and not for purposes of limitation. Furthermore, as used herein, the terms “comprise/comprises” or “include/includes” do not exclude the presence of other elements. Finally, reference signs in the claims are provided merely as a clarifying example and should not be construed as limiting the scope of the claims in any way.

1. An audio device configured to output audio content, comprising:
a controller; and
at least a first sensor configured to detect at least one usage parameter, wherein the controller is is configured to receive sensor information from the sensor indicative of the at least one usage parameter and
based on the sensor information, control settings of the audio device.

2-25. (canceled)

26. The audio device according to claim 1, wherein the controller is configured to recognize predetermined sensor information indicative of the at least one usage parameter and, in response thereto, control the settings of the audio device to a predetermined setting.

27. The audio device according to claim 1, wherein the audio device comprises at least one loudspeaker for outputting sound signals that are perceivable by a human listener.

28. The audio device according to claim 1, wherein the audio device is a mobile telephone or a headphone or a loudspeaker system.

29. The audio device according to claim 1, wherein the sensor comprises a position sensor configured to detect the position of a user relative to the audio device and to output sensor information to the controller indicative of the position of a user relative to the audio device.

30. The audio device according to claim 29, wherein the controller is configured to recognize predetermined sensor information indicative of the position of the user relative to the audio device and, in response thereto, control the settings of the audio device to predetermined settings of the audio device.

31. The audio device according to claim 1, wherein the audio device comprises at least one loudspeaker configured to generate ultrasonic audio signals for gesture control and wherein the sensor comprises a microphone configured to detect ultrasonic audio signals resulting from movement of at least a body part of a user and to output sensor information to the controller indicative of the movement of at least a body part of a user.

32. The audio device according to claim 31, wherein the controller is configured for gesture control, wherein the controller is configured to recognize predetermined sensor information indicative of a movement of at least a body part of a user, and in response thereto control the settings of the audio device to a predetermined setting of the audio device.

33. The audio device according to claim 1, wherein the sensor comprises a microphone configured to detect sound signals emanated from a user and to output sensor information to the controller indicative of emanated sound signals from a user.

34. The audio device according to claim 33, wherein the controller is configured for voice control, wherein the controller is configured to recognize predetermined sensor information indicative of a sound signal emanated from a user and, in response thereto control the settings of the audio device to a predetermined setting of the audio device.

35. The audio device according to claim 31, wherein the controller is configured to recognize predetermined sensor information indicative of movement of at least a body part of a user and/or predetermined sound signals emanated from a user and, based thereon, estimate the mood of the user and, in response to an estimated mood of the user, control the settings of the audio device to a predetermined setting of the audio device.

36. The audio device according to claim 1, wherein the sensor comprises a motion detection sensor, configured to determine physical movement of the user and to output sensor information to the controller indicative of body movement or body position of the user.

37. The audio device according to claim 36, wherein the controller is configured to recognize sensor information indicative of a predetermined motion or position of the body of a user and, in response thereto control the settings of the audio device to a predetermined setting of the audio device.

38. The audio device according to claim 1, wherein the sensor comprises a user identification sensor, configured determine an identification parameter of a user and to output sensor information to the controller indicative of the identification parameter of the user.

39. The audio device according to claim 38, wherein the controller is configured to recognize sensor information indicative of a predetermined identification parameter of a user and, in response thereto control the settings of the audio device to a predetermined setting of the audio device.

40. The audio device according to claim 1, further comprising a communication device configured for wireless communication.

41. The audio device according to claim 40, wherein the communication device is configured for wireless connection to a communication network, a further audio device, or to the Internet.

42. The audio device according to claim 1, wherein the audio device comprises a handover module configured to switch output of audio content from a first audio device to a second audio device.

43. The audio device according to claim 42, wherein the sensor is configured to output sensor information to the controller indicative of the position of a user relative to the first audio device, wherein the controller is configured to recognize predetermined sensor information indicative of the position of a user relative to the first audio device and in response thereto switch output of audio content from the first audio device to the second audio device.

44. The audio device according to claim 42, wherein the sensor is configured to output sensor information to the controller indicative of mutual positions of the first audio device and the second audio device, wherein the controller is configured to recognize sensor information indicative the mutual positions of the first audio device and the second audio device and, in response thereto, switch output of audio content from one of the first and the second audio device to the other of the first and the second audio device.

45. The audio device according to claim 1, wherein the controller is configured to recognize predetermined sensor information indicative of a usage parameter, and in response thereto, control a setting of a secondary device to a predetermined setting.

46. The audio device according to claim 45, wherein the secondary device is a lighting device and wherein the controller is configured to the control settings of emanated light from the secondary device based on sensor information.

47. The audio device according to claim 1, wherein the settings of the audio device comprise one or more of: outputted audio content, power mode of the at least first audio device, sound settings of outputted audio content, interaction of the audio device with additional audio devices or secondary devices, updating and/or synchronization of local settings on the device with remote settings.

48. The audio device according to claim 1, wherein predetermined settings of the audio device are stored in a local memory device of said audio device or stored on a remote memory device, which is accessible by wireless communication.

49. An audio system comprising at least a first and a second audio device, according to claim 42, wherein the first and the second audio device are configured for wireless operative communication with each other.
